(19) United States
(12) Patent Application Publication
(10) Pub. No.: US 2010/0302287 A1
(43) Pub. Date: Dec. 2, 2010

(54) DISPLAY DRIVING DEVICE AND DISPLAY DRIVING SYSTEM

(75) Inventors: Yukari KATAYAMA, Chigasaki (JP); Akihito Akai, Kawasaki (JP); Yoshiki Kurokawa, Tokyo (JP); Yusuke Uchida, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS ELECTRONICS CORPORATION

(21) Appl. No.: 12/785,982

(22) Filed: May 24, 2010

(30) Foreign Application Priority Data
May 26, 2009 (JP) 2009-126182

(51) Int. Cl. G09G 5/10; G09G 5/00

(52) U.S. Cl. 345/690; 345/211

(57) ABSTRACT

Overdrive over multiple frames is made more efficient in a display device drive circuit that drives a display device so slow in response that target brightness is not reached even after overdrive is performed for one frame. When a display gray scale is changed from a first gray scale to a second gray scale, a display driving device varies overdrive driving voltage according to the number of frames since the point of time of the change. This makes it possible to obtain high-speed luminance response. When the number of frames for which an identical image is continuously displayed is known beforehand, the number of frames is set in a display pattern setting register and a function of detecting timing of a change of images is provided. This enables efficient overdrive. At low temperature, further, a display image is updated once for several frames according to temperature information. This enhances the visibility of the image.

### CLAIM OF PRIORITY

The Present application claims priority from Japanese patent application JP 2009-126182 filed on May 26, 2009, the content of which is hereby incorporated by reference into this application.

### FIELD OF THE INVENTION

The present invention relates to display driving devices that drive a display panel and further display driving systems and in particular to a technology effectively applicable to, for example, the improvement of the moving image characteristics of a device low in response.

### BACKGROUND OF THE INVENTION

In recent years, television pictures such as one-segment images have been increasingly commonly displayed in mobile devices such as cellular phones and car navigation devices as an in-vehicle display device. With respect to in-car use, liquid crystal display panels have come to be used also in instrument panels and the like because of design or the like.

It is known that liquid crystal display devices are generally become slower in luminance response at low temperature. This poses a problem when a liquid crystal display device is used for in-car purposes in which a wide temperature range must be ensured. Mobile devices may be possibly used in snowcapped mountains or the like. Therefore, stricter temperature requirements are imposed on them than on liquid crystal for common home television.

In general, medium-sized and small-sized liquid crystal display devices are lower in response speed than liquid crystal for home television or the like because of a structural problem or an issue of cost.

As a method for improving response speed, there is known overdrive (hereafter, abbreviated as OD) as described in, for example, Japanese Unexamined Patent Publication No. 2006-47767 (Patent Document 1). The OD is a method for improving response speed by making the following correction when change in display gray scale occurs: a value obtained by adding a correction value corresponding to the magnitude of the change to a gray-scale value is used to drive liquid crystal.

As a method for improving response speed at low temperature, for example, the method described in Japanese Unexamined Patent Publication No. 2006-267653 (Patent Document 2) is proposed. The method is as follows: at low temperature, display data of one frame is stored in memory every multiple frames; a value in LUT corresponding to display data of a frame preceding by several frames read from the memory and display data of the present frame is outputted as display data; thus OD is performed with the display data of a frame preceding by several frames taken into account; and OD is performed over several frames. As a result, response speed at low temperature is improved in liquid crystal so low in response speed that brightness cannot be converged into target brightness in one frame even by impressing maximum (minimum) impressed voltage.

[Patent Document 1] Japanese Unexamined Patent Publication No. 2006-147767

[Patent Document 2] Japanese Unexamined Patent Publication No. 2006-267653

### SUMMARY OF THE INVENTION

The frame frequency of moving image data in one-segment broadcasting or delivered on the Internet does not always agree with the refresh frequency of a liquid crystal display device. In general, while the refresh frequency of liquid crystal display devices is 60 Hz, the frame frequency in one-segment broadcasting is 15 fps (frames per second) and that of moving image data delivered on the Internet or the like is also 15 fps. When one-segment broadcasting moving data is displayed in a cellular phone or the like, in general, the following processing is carried out: display data equivalent to display image converted into RGB data for one frame, obtained by decoding with a central processing unit (CPU) or a one-segment decoder, is written into a liquid crystal driver by the CPU in accordance with the refresh rate of a liquid crystal display device. When the content of one-segment broadcasting is displayed, the CPU writes identical display data into the liquid crystal driver four times.

When the content of one-segment broadcasting or the like is displayed with the above conventional technology, the following takes place: when display data of one frame is stored into memory every two frame, for example, change of display data in the one-segment broadcasting and display data storing timing get out of sync with a probability of ½. When change of display data in one-segment broadcasting and display data storing timing are synchronized with each other, OD driving is performed during a two-frame period. When they get out of sync, OD driving is performed only during one-frame period and as a result, response speed is not improved so much.

When the content of one-segment broadcasting or the like is displayed with the above conventional technology, a problem arises even when change of display data in the one-segment broadcasting and display data storing timing are synchronized with each other. When OD driving is performed with the influence of display data since an n-frame period before taken into account, image quality is degraded due to overcorrection unless the following processing is performed: correction data is set so that display brightness takes a value closest to target display brightness n frames later. Therefore, response takes two frames without exception and this makes it difficult to largely enhance response speed.

When display is made in a low-temperature environment with the above conventional technology, a different problem arises. When the rate of change of display images is higher than the response speed of liquid crystal and a high level of gray and a low level of gray are repeatedly displayed or on other like occasions, the following takes place: the display brightness is averaged and an intermediate level of gray is displayed. The entire display screen image is brought into an intermediate level of gray and a pattern to be displayed completely vanishes.

The invention has been made in consideration of the above problems and it is an object thereof to enhance the performance of display by overdrive driving of a liquid crystal display device low in response speed.

It is a concrete object of the invention to provide a display driving device in which the following is implemented when overdrive is performed over multiple frames in a display device drive circuit for driving a liquid crystal display device low in response speed: even when OD driving is performed with the influence of display data since n frames before taken into account, overcorrection is not caused; and further it is possible to perform overdrive driving in which the apparent response speed feels to be faster than n frames.

It is another concrete object of the invention to provide a display driving device in which it is possible to reduce moving image blurring and provide favorable image quality when the following moving image is displayed: a moving image, such as a moving image in one-segment broadcasting or a moving image delivered on the Internet, which is low in frame rate and whose pattern of writing from CPU to a liquid crystal driver is fixed.

It is further another object of the invention to provide a display driving device in which the following is implemented when display is made in a low-temperature environment: even when the rate of change of display images is sufficiently higher than the response speed of liquid crystal, a pattern to be displayed can be displayed so that it can be surely visually recognized.

The above and other objects and novel features of the invention will be apparent from the description in this specification and the accompanying drawings.

The following is a brief description of the gist of the representative elements of the invention laid open in this application:

To achieve the above objects, the following function is provided: a function for, when OD is performed over multiple frames, varying gray scale voltage for performing OD according to the number of frames since a change of display images. Luminance response is thereby converged at high speed to enhance moving image characteristics.

According to one concrete aspect of the invention, the following is implemented when OD is performed over multiple frames: using a look-up table, a driving gray-scale value is determined from the gray-scale value of an image before display image change and the gray-scale value of the present display image; and this driving gray-scale value is converted into gray scale voltage to carry out driving. It is thereby made possible to vary the gray scale voltage for performing OD according to the number of frames since a change of display images by changing look-up tables according to the number of frames since the change of display images. Luminance response is thereby converged at high speed to enhance moving image characteristics.

According to another concrete aspect of the invention, the following is implemented when OD is performed over multiple frames: using a look-up table, a first driving gray-scale value is determined from the gray-scale value of an image before display image change and the gray-scale value of the present display image; a second driving gray-scale value is obtained by multiplying the first driving gray-scale value by the value of a monotone decreasing function with the number of frames since the change of display images taken as a variable; and the second driving gray-scale value is converted into gray scale voltage to carry out driving. It is thereby made possible to vary gray scale voltage for performing OD according to the number of frames since a change of display images. Luminance response is thereby converged at high speed to enhance moving image characteristics.

According to further another concrete aspect of the invention, the following are provided: a display pattern setting register for setting a number of periods during which an identical display image continues; an image change detection circuit for detecting that the display gray-scale value one period before and the present display gray-scale value are different from each other; and a counter that operates according to the display pattern setting register and the detection timing of the image change detection circuit. A display gray-scale value is stored in a storage circuit in a drive circuit according to the value of the counter and further the look-up tables are changed according to the counter value. It is thereby made possible to reliably perform overdrive for multiple frames and vary gray scale voltage for performing OD according to the number of frames since a change of images. Luminance response is thereby converged at high speed to enhance moving image characteristics.

According to further another concrete aspect of the invention, the following are provided: a display pattern setting register for setting a number of periods during which an identical display image continues; an image change detection circuit for detecting that the display gray-scale value one period before and the present display gray-scale value are different from each other; and a counter that operates according to the display pattern setting register and the detection timing of the image change detection circuit. A display gray-scale value is stored in a storage circuit in a drive circuit according to the value of the counter. It is thereby made possible to reliably perform overdrive for multiple frames. Further, the output value of a circuit for computing the monotone decreasing function with the value of the counter taken as a variable is used as a driving gray-scale value. It is thereby made possible to vary gray scale voltage for performing OD according to the number of frames since a change of images. Luminance response is thereby converged at high speed to enhance moving image characteristics.

According to further another concrete aspect of the invention, the following are provided in a drive circuit for a display device: a temperature detection circuit that detects and outputs temperature information pertaining to ambient temperature; and a counter having a function of varying the maximum value of a count according to the temperature information. The drive circuit stores a first display gray-scale value supplied from the central processing unit in a first storage circuit according to the value of the counter. Further, it stores a second gray-scale value stored in the first storage circuit in a second storage circuit according to the value of the counter. It is thereby made possible to perform OD for multiple frames. Thus, even when the luminance response of a display panel is very slowed at low temperature, the averaging of brightness is prevented to enhance the viewability of images. Further, multiple look-up tables are changed and used according to the value of the counter. It is thereby made possible to vary gray scale voltage for performing OD according to the number of frames since a change of images. Luminance response is thereby converged at high speed to enhance moving image characteristics.

According to further another concrete aspect of the invention, the following are provided in a drive circuit for a display device: a temperature detection circuit that detects and outputs temperature information pertaining to ambient temperature; and a counter having a function of varying the maximum value of a count according to the temperature information. The drive circuit stores a first display gray-scale value supplied from the central processing unit in a first storage circuit according to the value of the counter. Further, it stores a second gray-scale value stored in the first storage circuit in a second storage circuit according to the value of the counter. It is thereby made possible to perform OD for multiple frames. Thus, even when the luminance response of a display panel is very slowed at low temperature, the averaging of brightness is prevented to enhance the viewability of images. Further, it is made possible to vary gray scale voltage for performing OD according to the number of frames since a change of images by taking the following process: the output value of the look-up table is multiplied by the output value of a circuit for computing a monotone decreasing function with the value of the counter taken as a variable. Luminance response is thereby converged at high speed to enhance moving image characteristics.

The following is a brief description of the gist of effects obtained by the representative elements of the invention laid open in this application:

It is possible to enhance the performance of display by overdrive driving of a liquid crystal display device low in response speed.

### BRIEF DESCRIPTION OF THE DRAWINGS

FIG. 1 is a block diagram illustrating an example of the configuration of a display driving device in a first embodiment of the invention;

FIG. 2 is a timing chart illustrating the operation of a memory storing timing unit and a display data storage circuit in the first embodiment;

FIG. 3 is a timing chart illustrating the operation of an overdrive circuit and a display panel in the first embodiment;

FIG. 4 is a flowchart illustrating the operation of a memory storing timing generation circuit in the first embodiment;

FIG. 5 is a block diagram illustrating an example of the configuration of a display driving device in a second embodiment of the invention;

FIG. 6 is a timing chart illustrating the operation of a display device in the second embodiment;

FIG. 7 is an explanatory drawing illustrating an example of a display image in the second embodiment;

FIG. 8 is an explanatory drawing illustrating a display image in which degradation in image quality, which is caused by slow response of a liquid crystal, occurred in relation to the second embodiment;

FIG. 9 is a block diagram illustrating an example of the configuration of an overdrive circuit and its peripheral circuit in a third embodiment of the invention;

FIG. 10 is an explanatory drawing illustrating the relation between counter values and gray-scale values computed in an overdrive circuit in the third embodiment;

FIG. 11 is a block diagram illustrating an example of the configuration of a display driving device in a fourth embodiment of the invention;

FIG. 12 is a timing chart illustrating the operation of a display device in the fourth embodiment; and

FIG. 13 is an explanatory drawing theoretically illustrating the configuration of an active matrix display panel.

### DETAILED DESCRIPTION OF THE PREFERRED EMBODIMENTS

### 1. Summary of the Preferred Embodiments

First, description will be given to the overview of embodiments representative of the invention disclosed in this specification. The parenthesized reference numerals in the drawings referred to in the description of the overview of representative embodiments just indicate what is contained in the concept of constituent elements to which the numerals are affixed as examples.

(1) <Gradation in Overdrive Voltage>

A display driving device (100) in a representative embodiment of the invention forms gray scale driving voltage based on a display gray-scale value supplied from a central processing unit (102) and drives a display panel (105). It carries out overdrive control. In overdrive control, the display driving device responds to a change of display gray-scale values supplied from the central processing unit. After gray scale driving voltage arising from a display gray-scale value before the change is reached, it drives the display panel with the following voltage: the difference multiple gray scale driving voltages and the gray scale driving voltage before the change is larger than the difference the gray scale driving voltage corresponding to a gray-scale value after the change and the gray scale driving voltage before the change in terms of absolute value.

(2) <Multiple LUTs>

The display driving device in Section (1) above includes: multiple look-up tables (114 to 117) that receives a display gray-scale value before the change and a display gray-scale value after the change and forms an output corresponding to the inputted display gray-scale values; a selector (118) for selecting the outputs of the look-up tables; and a timing generation circuit (122) that controls selection by the selector. The timing generation circuit changes the selected look-up tables in accordance with the number of periods that lapse with respect to display frame periods starting at a change of display gray-scale values supplied from the central processing unit. Overdrive control is carried out which performs driving with the multiple gray scale driving voltages large in terms of absolute value based on the output selected by the selector.

(3) <Monotone Decreasing Function>

The display driving device in Section <1>above includes: a look-up table (114) that receives a display gray-scale value before the change and a display gray-scale value after the change and forms an output corresponding to the inputted display gray-scale values; a computation circuit (901) that receives the multiple outputs of the look-up table and carries out computation; and a timing generation circuit (122) that controls computation by the computation circuit. The computation circuit computes a monotone decreasing function with the following number of periods taken as a variable: the number of periods that lapse with respect to display frame periods starting at a change of display gray-scale values supplied from the central processing unit. It multiplies the result of this computation by the outputs of the look-up table. The timing generation circuit supplies the variable to the computation circuit. Overdrive control is carried out which performs driving with multiple gray scale driving voltages large in terms of absolute value based on the output of multiplication by the computation circuit.

(4) <Buffer Memory>

The display driving device in Section (2) or (3) above includes a buffer memory (110) that temporarily stores data of display gray-scale values at each interval between changes of display gray-scale values supplied from the central processing unit. The look-up table forms an output based on a display gray-scale value supplied from the central processing unit in synchronization with display timing and a display gray-scale value read from the buffer memory in synchronization with display timing.

(5) <Intervals Between Changes of Display Gray-Scale Values>

In the display driving device in Section (4) above, the interval between changes of display gray-scale values is a period whose minimum unit is one display frame period. The timing control circuit includes a counter that counts the duration of intervals between changes of the display gray-scale values. Then it carries out control to rewrite the display gray-scale values of identical pixels on the buffer memory in each period of the counting operation of the counter.

(6) The display driving device in Section (5) above includes registers (107, 504) in which the maximum value of the counter is initially set by the CPU.

(7) <Compression and Decompression>

The display driving device in Section (4) above includes: a compression circuit (109) that compresses display gray-scale values supplied from the central processing unit; and a second decompression circuit (111) that decompresses the output of the buffer memory. The buffer memory stores display gray-scale values compressed at the compression circuit. The look-up table receives: display gray-scale values obtained by decompressing compressed display gray-scale values read from the buffer memory at the second decompression circuit; and display gray-scale values supplied not by way of them. This makes it possible to reduce the storage capacity of the buffer memory.

(8) <Exclusion of Still Images from OD Control>

In the display driving device in Section (7) above, the look-up table carries out the overdrive control on condition that the following values do not agree with each other: display gray-scale values supplied by way of the compression circuit and the first decompression circuit; and corresponding display gray-scale values supplied by way of a second decompression circuit (111) that decompresses the output of the buffer memory. This makes it possible to discriminate a still image in which image degradation due to compression and decompression become obvious and to exclude it from the target of overdrive control.

(9) <Counting Number of Display Frame Periods that Lapse>

In the display driving device in Section (2) above, the timing control circuit includes a counter (123) that repeats the operation of counting the number of display frame periods that lapse from an initial value to a specified value. It changes selection by the selector (118) based on the count value of the counter.

(10) <Counting Number of Display Frame Periods that Lapse>

In the display driving device in Section (3) above, the timing control circuit includes a counter (123) that repeats the operation of counting the number of the display frame periods that lapse from an initial value to a specified value. It supplies the computation circuit (901) with the count value of the counter as a variable.

(11) <OD by Area in Display Panel>

A display driving device in a representative embodiment of the invention forms gray scale driving voltage based on a display gray-scale value supplied from a central processing unit and drives a display panel. It responds to a change of display gray-scale values supplied from the central processing unit. After gray scale driving voltage arising from a display gray-scale value before the change is reached, it carries out control to drive the display panel with the following voltage: multiple gray scale driving voltages larger than the gray scale driving voltage arising from a gray-scale value before the change in terms of absolute value. The display driving device carries out this control with respect to each of the display areas in the display panel.

(12) <Display Driving System>

A display driving system in a representative embodiment of the invention includes: a display driving device in any of Sections (1) to (11) above; a central processing unit that supplies display gray-scale values to the display driving device and controls it; and a display panel driven by driving voltage formed by the display driving device. The display panel is formed by: arranging pixel electrodes (1302) with specific TFTs (1301) coupled thereto in a matrix pattern opposite to a common electrode (1303); and providing multiple scanning lines comprising the selection paths of the TFTs and multiple signal lines comprising the current paths of the TFTs. The display driving device drives the signal lines in synchronization with driving of the scanning lines.

### 2. Further Detailed Description of the Preferred Embodiments

More detailed description will be given to embodiments.

Hereafter, detailed description will be given to embodiments of the invention with reference to the drawings. In all the drawings illustrating embodiments, identical parts will be marked with identical reference numerals as a rule and the repetitive description thereof will be omitted.

### First Embodiment

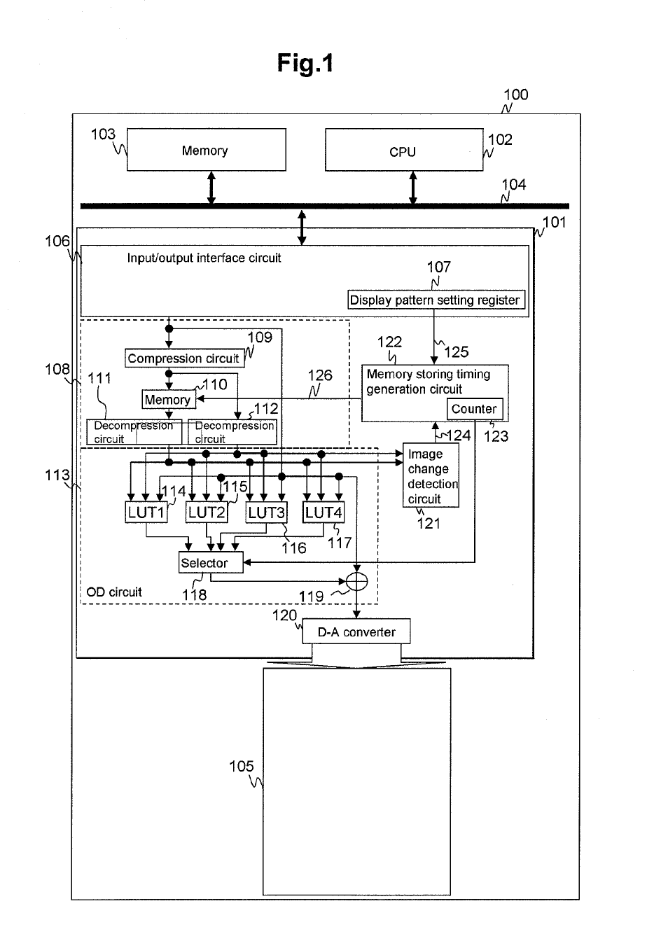

FIG. 1 illustrates an example of the block configuration of a display driving device in a first embodiment of the invention. Reference numeral 100 denotes a display driving system applied to a cellular phone or the like; 101 denotes a display driving device such as a liquid crystal driver; 102 denotes a central processing unit (CPU) that comprehensively controls the display driving system 100; 103 denotes a memory such as RAM for storing display data and the like; 104 denotes an internal bus; and 105 denotes a display panel that is driven by the display driving device 101 and makes display. In the description of this embodiment, attention is paid to display gray-scale value as display data. Even though not explicitly stated, display data refers to display gray-scale value.

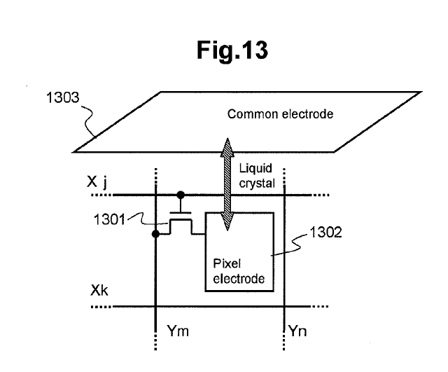

The display panel 105 may be liquid crystal panel, organic EL panel, PDP, FED, electronic paper, or the like as long as it is a display panel. FIG. 13 schematically illustrates the configuration of a display panel using TFTs. The display panel 105 in the example illustrated in FIG. 13 is of active matrix type. In this type of display panel, multiple pixel electrodes 1302 with specific TFTs 1301 coupled thereto are arranged in a matrix pattern opposite to a common electrode 1303; and there are provided multiple scanning lines Xj, Xk . . . comprising the selection paths of the TFTs 1301 and multiple signal lines Ym, Yn . . . comprising the current paths of the TFTs 1301. FIG. 13 representatively shows one pixel electrode 1302. In actuality, however, liquid crystal is filled between a large number of the pixel electrodes 1302 arranged in a matrix pattern and the other side of the common electrode 1303 one side of which is coupled to the ground of the circuit or the like. The signal lines Ym, Yn . . . are coupled with the drains of the corresponding TFTs 1301; and the scanning lines Xj, Xk . . . are coupled with the gates of the corresponding TFTs 1301. The display panel may be of simple matrix type.//

Reference numeral 106 denotes an input/output interface circuit that includes a mode register group, not shown, with which various operation modes are set by the CPU 102 and receives display data from the CPU 102 or the memory 103. Reference numeral 107 denotes a display pattern setting register that is one register in the register group provided in the input/output interface circuit 106 and is used to set a display pattern for display data used at the memory storing timing generation circuit 122 described later. For example, once for how many frames a change of moving image display data supplied from the CPU 102 should be caused is specified here. Reference numeral 108 denotes a display data storage circuit, which has a function of storing display data in a memory 110 as a buffer memory in accordance with the output timing of the memory storing timing generation circuit 122. The display data storage circuit 108 is comprised of the memory 110, a compression circuit 109, a decompression circuit 111, and a decompression circuit 112. The capacity of the memory 110 can be reduced by compressing image data before it is stored in the memory 110 and this produces cost reduction effect. In this invention, data not always has to be compressed before it is stored in the memory 110. Instead, the following process may be taken: the compression circuit 109, decompression circuit 111, or decompression circuit 112 is not provided; and uncompressed display data is stored in the memory 110 and directly outputted from the memory 110.

Reference numeral 113 denotes an overdrive circuit for generating overdrive driving values for the enhancement of moving image performance. It is comprised of multiple, for example, four look-up tables (LUT1, LUT2, LUT3, LUT4) 114, 115, 116, 117, a selector 118, and an adder 119. Reference numeral 120 denotes a D-A converter that converts a digital gray-scale value supplied from the adder 119 into an analog gray scale voltage value. Reference numeral 121 denotes an image change detection circuit. It detects whether or not display data stored in the memory 110 as the output of the decompression circuit 111 and the present display data as the output of the decompression circuit 112 disagree with each other. When the output of the decompression circuit 111 disagrees, even if partly, with the output of the decompression circuit 112, it is determined that images have been changed. Then an image change signal 124 is outputted to the memory storing timing generation circuit 122. The memory storing timing generation circuit 122 generates a memory update signal 126 indicating timing with which data should be stored in the memory 110 based on the following: the display pattern setting information 125 from the display pattern setting register 107 and the image change signal 124 as the output signal of the image change detection circuit 121. The memory storing timing generation circuit 122 is provided therein with a counter 123 that performs counting operation in synchronization with the memory update signal 126 and is incremented by one for one frame. The selector 118 selects one of the outputs of the look-up tables 114 to 117 according to the count value of this counter 123 and outputs it to the adder 119. The counter 123 can repeat the operation of counting the number of periods that lapse with respect to display frame periods starting at a change of display gray-scale values supplied from the CPU 102. This counting operation is carried out from an initial value to the set value in the register 107.

In case of a display driving device for a panel, such as a liquid crystal panel, which is controlled by analog voltage, the D-A converter 120 is used. There are also display panels driven by current, pulses, or the like. The D-A converter 120 can be changed according to the driving method for the display panel and may be any type of a block as long as it has a circuit function of converting the digital value of each display pixel into a signal that can drive the display panel. Even if the circuit block of the D-A converter 120 is replaced with a circuit block having a different function, that does not have an influence on the invention at all.

The look-up tables 114 to 117 are directly supplied with image data inputted from the CPU 102 to the input/output interface 106 and further supplied with the outputs of the decompression circuits 111, 112. The adder 119 is directly supplied with image data inputted from the CPU 102 to input/output interface 106 and further supplied with a correction value selected by the selector 118. The following are stored in the look-up tables 114 to 117: a correction data corresponding to the gray-scale value outputted from the decompression circuit 111 and the gray-scale value of image data inputted from the CPU 102 to the input/output interface 106. The outputs of the look-up tables 114, 115, 116, 117 are sequentially selected by the selector 118 according to the count value of the counter 123 and supplied to the adder 119. The adder 119 adds correction data to image data inputted from the CPU 102 to the input/output interface 106 and outputs the result of this addition. // The operation of gradually increasing or decreasing a correction value sequentially selected by the selector 118 according to the count value of the counter 123 is repeated and the display panel 105 is thereby overdrive controlled. It is determined whether or not a display gray-scale value supplied by way of the compression circuit 109 and the decompression circuit 112 and a corresponding display gray-scale value supplied by way of the decompression circuit 111 agree with each other. The look-up tables 114, 115, 116, 117 carry out the overdrive control on condition that they disagree with each other. Even when image degradation due to compression and decompression is obvious, with respect to a still image, agreement is determined by making a comparison by compressed and decompressed data. In this case, the look-up tables 114, 115, 116, 117 output a correction value of “0” and exclude it from the target of overdrive control.

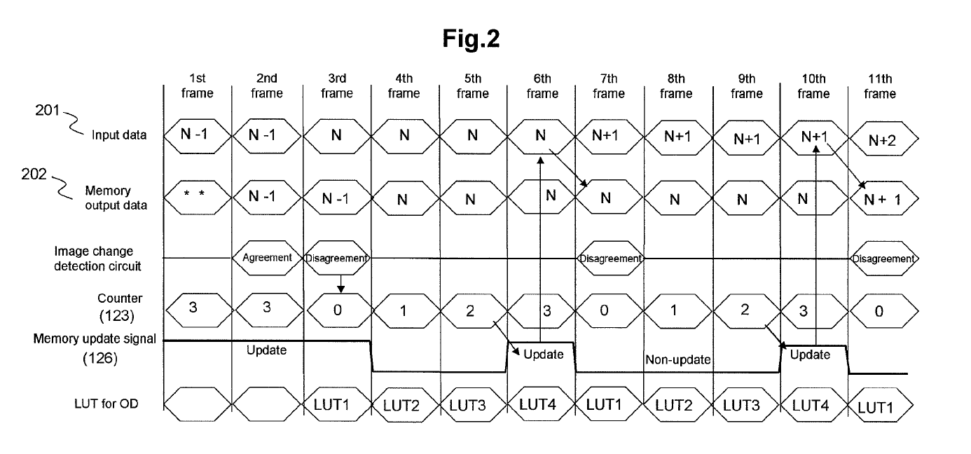

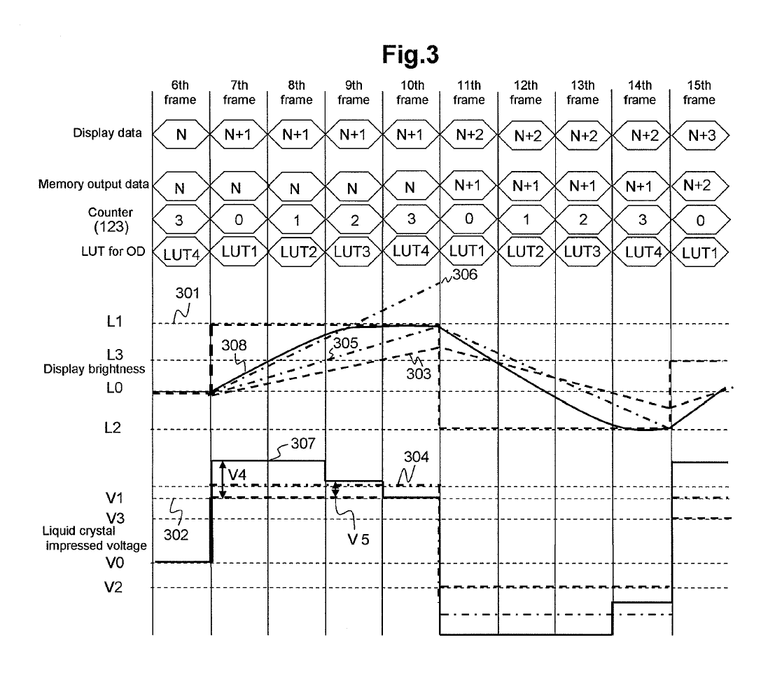

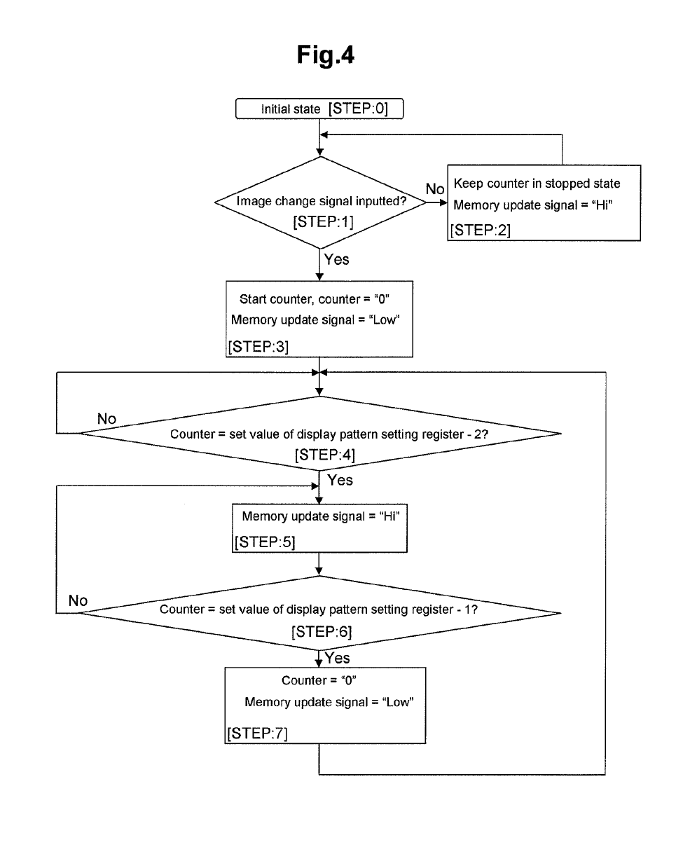

Description will be given to the operation of the first embodiment with reference to FIG. 2, FIG. 3, and FIG. 4. FIG. 2 is a timing chart illustrating the operation of the memory storing timing generation circuit 122 and the display data storage circuit 108 in the first embodiment; FIG. 3 is a timing chart illustrating the operation of the OD circuit in the first embodiment and the display panel; and FIG. 4 is a flowchart illustrating the operation of the memory storing timing generation circuit 122.

In the description of the first embodiment, a liquid crystal driving system for displaying the content of one-segment broadcasting by a liquid crystal display panel low in response speed will be taken as an example. In the timing charts, attention is paid to one pixel (one sub-pixel as for color images) within a frame for the sake of simplicity of explanation.

First, description will be given to the operation of the memory storing timing generation circuit 122 and the display data storage circuit 108 in the first embodiment with reference to FIG. 2 and FIG. 4.

One-segment broadcasting is carried out at 15 fps and display is changed 15 times per second. The CPU 102 reproduces display images using an antenna, a tuner, a decoder, or the like, which is not shown, and stores them in the frame buffer in the memory 103. Since the display panel 105 operates at 60 fps, the CPU 102 repeatedly transfers an identical image four times from the memory 103 to the display driving device (also referred to as liquid crystal driver) 101 using the internal bus 104. The CPU 102 sets a display pattern in the display pattern setting register 107 before the content of one-segment broadcasting is displayed. In one-segment broadcasting, each identical data is transferred four times from the CPU 102 to the display driving device 101. Therefore, this description is based on the assumption that “4” is set in the display pattern setting register 107. As illustrated in FIG. 4, the liquid crystal driver 101 receives identical data as input data 201 by four times through the input/output interface circuit 106. In the initial state, the memory update signal 126 is in “Hi” state which indicates “update.” Therefore, input data N−1 of the first frame is compressed at the compression circuit 109 and stored in the memory 110. The memory 110 stores input data equivalent to one frame. Next, input data N−1 of the second frame is received through the input/output interface circuit 106. Then the data stored in the memory 110 is decompressed by the decompression circuit 111 and data N−1 is outputted as memory output data 202. The input data 201 is compressed at the compression circuit 109, decompressed at the decompression circuit 112, and outputted to the image change detection circuit 121. At the image change detection circuit 121, two pieces of the inputted data are both N−1 and they agree with each other; therefore, the image change signal 124 is not outputted. At the memory storing timing generation circuit 122, as illustrated in FIG. 4, it is determined whether or not the image change signal 124 is present (Step 1). Since the image change signal 124 has not been outputted, the counter 123 remains in stopped state and the memory update signal 126 is also kept “Hi” (Step 2). Next, the third frame comes and the input data 201 becomes N. Thus the output of the decompression circuit 112 is N and the memory output data 202 as the output of the decompression circuit 111 is N−1. Since they disagree with each other, the image change signal 124 is outputted. The memory storing timing generation circuit 122 determines that the image change signal 124 has been outputted (Step 1) and initializes the counter 123 to “0” to start counting operation. Further, it sets the memory update signal 126 to “Low” (Step 3). In the third frame, the memory update signal 126 is “Hi” and thus display data N is stored in the memory 110. In the fourth frame, N is outputted as the output of the decompression circuit 111. When the fourth frame comes, the counter 123 is incremented by one and is set to 1. Since the value of the counter 123 is not 2 (=the value in the display pattern setting register−2), the memory update signal is kept “Low” and the output value of the memory 110 is unchanged (Step 4). When the fifth frame comes, the counter 123 is incremented by one and set to 2. Since the counter value is 2, the counter value is equal to the value of the display pattern setting register value−2. Therefore, the memory update signal 126 is set to “Hi” (Step 5). When the sixth frame comes, the value stored in the memory is updated to the present input data value N because the memory update signal 126 is at “Hi”. The counter 123 is incremented by one and set to 3. Since the counter value is 3, the counter value is equal to the display pattern setting register value−1 (Step 6). The counter value is reset to 0 and the memory update signal 126 is set to “Low” (Step 7). Then the flow returns to Step 4. In the seventh, eighth, and ninth frames, the memory update signal 126 is at “Low.” Therefore, even when the input data 201 is varied into N+1, the content of the memory 110 is not updated and remains N. When the value of the counter 123 becomes 2 in the ninth frame, the memory update signal is set to “Hi” in the next frame. For this reason, the memory 110 is updated in the 10th frame and the input value N+1 of the 10th frame is outputted as the output value of the decompression circuit 111 in the 11th frame. In the example in FIG. 2, the value of the input data 201 and the value of the memory output data 202 may be identical with each other before the first sixth frame and overdrive cannot be efficiently performed. In the seventh and following frames, however, the memory output data 202 takes the value of the frame four frames before and it is possible to efficiently perform overdrive over multiple frames. The counter 123 in the memory storing timing generation circuit outputs a value corresponding to the number of frames since a change of images.

Detailed description will be given to the operation of the overdrive unit 113 with reference to FIG. 3. It will be assumed that: the display gray scale of some pixel supplied from the CPU 102 in the sixth frame is L0; that in the seventh frame to the 10th frame is L1; that in the 11th frame to the 14th frame is L2. The display panel (also referred to as liquid crystal panel) 105 in the first embodiment is low in response. Therefore, when liquid crystal impressed voltage V1 (302) corresponding to gray scale L1 is supplied in the seventh frame to the 10th frame, the response waveform of brightness is as indicated by reference numeral 303. Thus even after four frames passes, the brightness does not reach the target brightness (301) corresponding to L1. To cope with this, such overdrive voltage 304 that the brightness reaches the target brightness 301 four frames later is applied over a four-frame period. As a result, the response brightness waveform becomes as indicated by reference numeral 305 and the brightness reaches the target brightness four frames later. However, the response waveform is gentle and the moving image does not look clear. When voltage equal to or higher than overdrive voltage 304 is applied over a four-frame period, the response brightness waveform becomes as indicated by reference numeral 306 and the target brightness is largely exceeded. This leads to degradation in image quality. In the first embodiment, liquid crystal impressed voltage is varied on a frame-by-frame basis as indicated by reference numeral 307 according to the number of frames since a change of images using four different look-up tables 114 to 117. As a result, it possible to accelerate rise of the response brightness waveform like response brightness waveform 308 without causing such degradation in image quality as the target brightness waveform is exceeded. Thus it is possible to largely enhance moving image performance. In the first embodiment, as mentioned above, the counter 123 in the memory storing timing generation circuit 122 outputs a value corresponding to the number of frames since a change of images. The selector 118 selects the look-up tables 114 to 117 according to the value of the counter 123. As a look-up table output value corresponding to the combination of the output gray-scale value L0 of the memory and the display gray-scale value L1 of the present frame, for example, the following values are set: V1+V4 (V4 is the maximum impressed voltage of this display device) is set in the look-up table (LUT1) 114 and the look-up table (LUT2) 115; V5 is set in the look-up table (LUT3); and “0” is set in the look-up table (LUT4). As a result, the brightness waveform rises at the maximum speed in the seventh frame and the eighth frame; and in the ninth frame, control is so carried out that the target brightness L1 is reached at the end of the ninth frame by impressed voltage V2+V5. In the 10th frame, the target brightness L1 has been already reached; therefore, steady-state impressed voltage V1 corresponding to the display brightness L1 is applied and the target brightness L1 is maintained. The high-speed response brightness waveform 308 indicated in FIG. 3 can be achieved by carrying out the above-mentioned operation.

In the first embodiment described up to this point, the following process is taken when moving images, such as moving image in one-segment broadcasting, having a fixed display pattern is displayed: the display pattern is taken into account and overdrive is performed by gradually increasing or decreasing gray scale driving voltage. This makes it possible to largely enhance moving image performance.

In the first embodiment, the display pattern is a four-frame period. Even when the number of consecutive frames of an identical image is alternately changed, like two frames, three frames, two frames, three frames, and so on, the same control can be achieved by taking the following process: it is made possible to set two values in the display pattern register and these values are alternately referred to.

### Second Embodiment

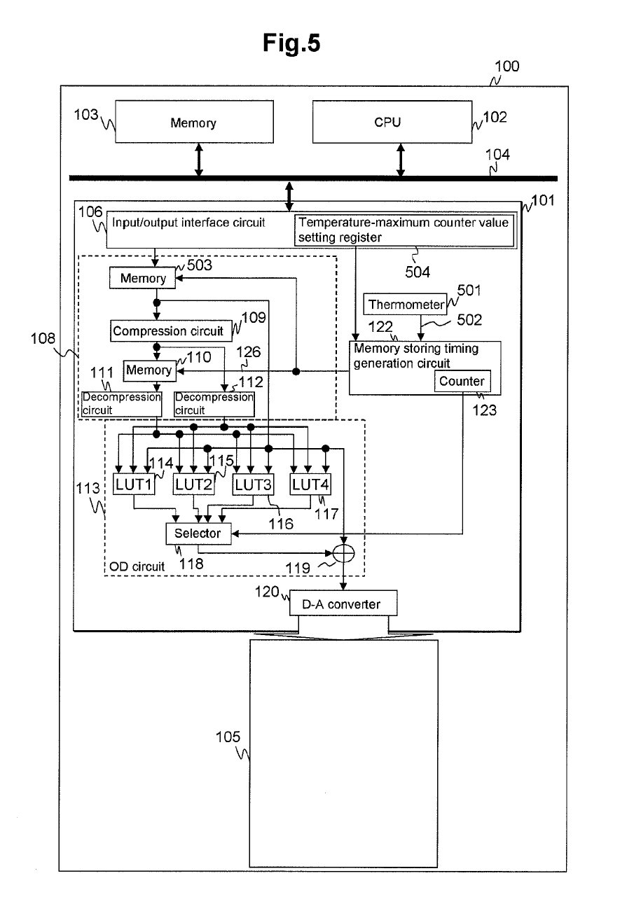

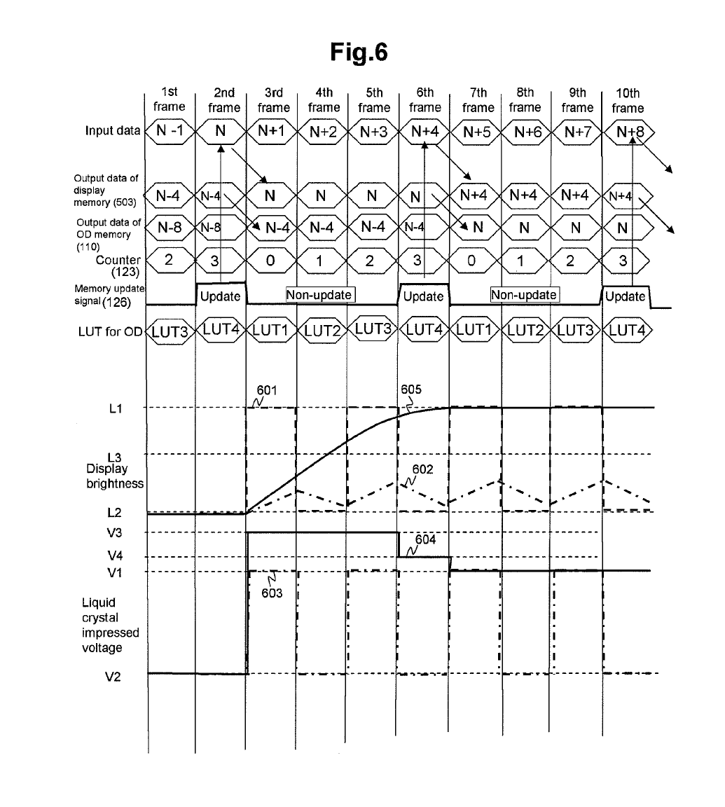

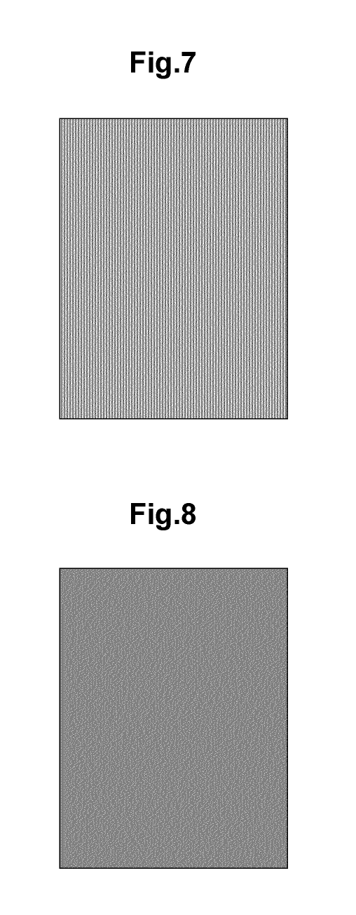

Description will be given to a second embodiment with reference to FIG. 5, FIG. 6, FIG. 7, and FIG. 8. In general, small liquid crystal panels of cellular phones and the like are slower in response than liquid crystal panels for televisions because of structure, cost, and the like. Cellular phones and in-vehicle liquid crystal panels are used in a severe use environment and they must accommodate to a wide temperature range from high temperature to low temperature. It is commonly known that liquid crystal panels become slow in response in low temperature. If a high-speed moving image is displayed in a liquid crystal panel very slow in response, a problem arises. The brightness is averaged and the display image is evenly turned gray or the like and becomes invisible. As an example, it will be assumed that the image of gray vertical lines illustrated in FIG. 7 is horizontally scrolled with the same magnitude as the width of each vertical line. It will be assumed that the brightness of the gray scale of lighter gray is L1 and the brightness of the gray scale of darker gray is L2. Then driving is performed with the driving voltages V1, V2 corresponding to the brightnesses L1, L2, that is, by driving voltage waveform 603 as illustrated in FIG. 7. In this case, the ideal brightness waveform is as indicated by reference numeral 601. In case of a very slow liquid crystal panel, its response of brightness does not reach the target brightness and the brightness waveform becomes as indicated by reference numeral 602. As a result, the display image become averagely dark gray as illustrated in FIG. 8 and the pattern is difficult to view. In consideration of this problem, the second embodiment is so configured that the visibility is improved, especially, at low temperature. This will be described below:

FIG. 5 illustrates an example of the block configuration of a display driving device in the second embodiment. The block configuration of the second embodiment is different from that of the first embodiment shown in its block diagram: the display pattern setting register 107 or the image change detection circuit 121 is not provided; temperature information 502 as the output of a thermometer 501 is inputted as input information to the memory storing timing generation circuit 122; a memory 503 for storing the present display data is provided in a stage preceding the compression circuit in the display data storage circuit 108; and a temperature-maximum counter value setting register 504 is provided in the input/output interface circuit 106. The memory 503 is utilized as a buffer memory substituted for the frame buffer allocated to part of the memory 103. The temperature-maximum counter value setting register 504 is used to set the relation between temperature and the maximum count value of the memory storing timing counter 123. In the temperature-maximum counter value setting register, a maximum count value versus temperature can be determined. The temperature-maximum counter value setting register 504 may be so configured that a value is specified as in the look-up table. Or, the following process may be taken: the coefficients (A,B) of a function with temperature (tmp) taken as a variable as shown by Mathematical Expression 1 are set as register values and setting is made so that the value (Max_cnt) of the function becomes equal to the maximum count value. The expression of the function is not limited to Mathematical Expression 1. The other respects in the configuration are the same as in FIG. 1 and the detailed description thereof will be omitted

[Mathematical Expression 1]

Max_cnt=A^{(B-tmp)} 1

FIG. 6 illustrates an example of a timing chart illustrating the operation of the second embodiment. As an example, it will be assumed that: the thermometer 501 outputs some temperature information t502; in setting information of the temperature-maximum count value setting register 504, the maximum count value corresponding to temperature t is 3. Since the maximum count value is 3, the memory storing timing counter 123 is incremented by one for one frame as illustrated in FIG. 6. In the frame next to a frame whose count is 3, the counter is reset and the count becomes 0. When the value of the counter is 3, the memory update signal 126 becomes active and the input data N are stored in the memory 503: input data N as the output of the input/output interface circuit 106; and display memory output data N−4 obtained by compressing the output data of the memory 503 is stored in the memory 110. During a period equivalent to four frames from when the count value is 1 to when the count value is the next 0, the output of the decompression circuit 111 is display data N−4; and the output of the decompression circuit 112 is display data N. As the result of this operation, display data is updated once for four frames and this enables stable display. The selector 118 selects one from among the output values of the LUTs 1 to 4 according to the count value of the memory storage timing counter 123. As an example, it will be assumed that the display gray scale of some sub-pixel in an image N−4 is L2 and the display gray scale of some sub-pixel in an image N is L1. It will be assumed that: the output of the look-up table (LUT1) 114, look-up table (LUT2) 115, look-up table (LUT3) 116 to the input gray-scale values L2, L1 is driving gray scale V3; and the output of the look-up table (LUT4) 117 to the input gray-scale values L2, L1 is driving gray scale V4. In this case, the impressed voltage to the liquid crystal is as indicated by reference numeral 604 and the luminance response waveform is as indicated by reference numeral 605. When the driving voltage V3 to the liquid crystal is the maximum voltage supplied to the liquid crystal, control is so carried out that the following is implemented: the brightness waveform rises at the maximum speed in the third to fifth frames; and in the sixth frame, the target brightness L1 is reached just at the end of the sixth frame. It is made possible to respond at the maximum response speed of this liquid crystal at the temperature by carrying out this operation. The display in the liquid crystal panel in the sixth frame is as illustrated in FIG. 7 as an example. Though the operation is slowed and the image becomes clearly, the visibility of the display image can be enhanced and it is possible to prevent the brightness from being averaged to make the pattern invisible as illustrated in FIG. 8 as an example.

### Third Embodiment

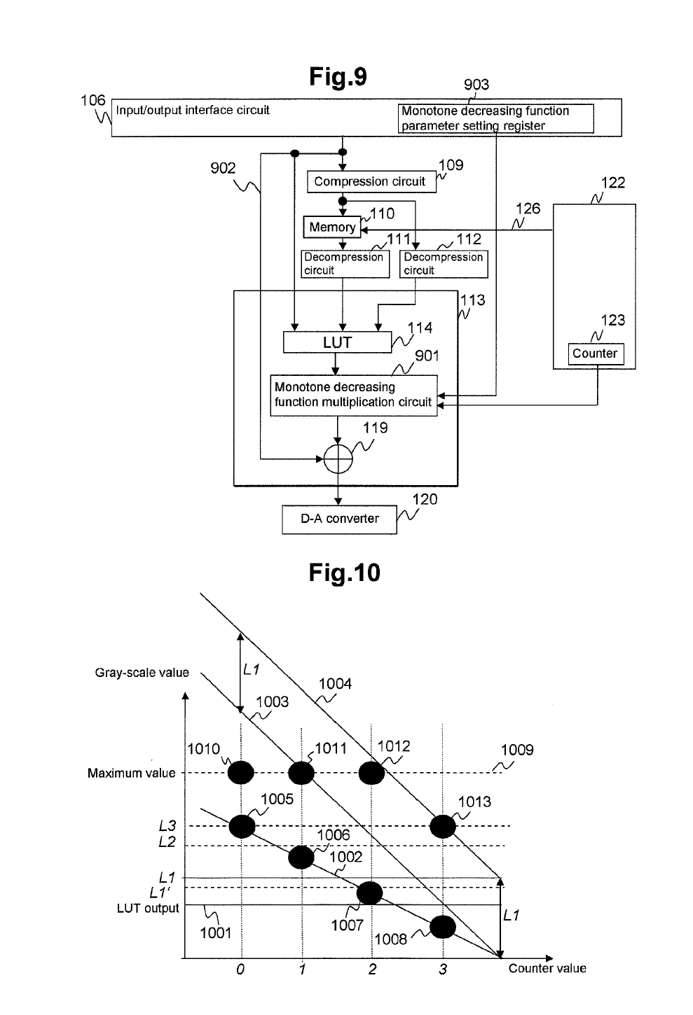

Description will be given to a third embodiment with reference to FIG. 9 and FIG. 10. The third embodiment performs the same operation as the first embodiment and the second embodiment; however, it is different from the first embodiment and the second embodiment in the configuration of the overdrive circuit 113. The overdrive circuit 113 in the third embodiment can be substituted for the overdrive circuits in the first embodiment and the second embodiment. FIG. 9 illustrates an example of the block configuration of the overdrive circuit 113 in the third embodiment and a peripheral circuit thereof. The third embodiment is provided with only one look-up table (LUT). In the third embodiment, the output value of the look-up table 114 is multiplied by the value of a monotone decreasing function with the count value of the memory storing timing counter 123 taken as a variable at a monotone decreasing function multiplication circuit 901.

FIG. 10 is a drawing explaining the operation of the third embodiment. First, it will be assumed that at some sub-pixel, a gray-scale value of L1 is outputted as the output signal 902 of the input/output interface circuit 106. Further, it will be assumed that the gray-scale value of the same sub-pixel obtained by decompressing the stored data of the memory 110, which stores data of the immediately preceding frame compressed at the compression circuit 109, at the decompression circuit 111 is L2. Furthermore, it will be assumed that the gray-scale value of the same sub-pixel obtained by compressing and decompressing the present display image is L1′. It will be assumed that the output of the look-up table 114 obtained from the three values, L1, L1′, L2 is LUT output 1001. The monotone decreasing function multiplication circuit 901 includes a circuit that calculates a function whose function value decrease monotonously as a variable of a monotone decreasing function. In this monotone decreasing function, adjustment can be made on a panel-by-panel basis by setting a value in the monotone decreasing function parameter setting register 903 provided in the input/output interface circuit 106. In the third embodiment, this monotone decreasing function is a linear function having a negative slope and a slope and an intercept are set in the monotone decreasing function parameter setting register 903. It will be assumed that the monotone decreasing function with the present setting of the monotone decreasing function parameter setting register 903 is expressed by straight line 1002. In this case, the value of the straight line 1002 decrease as indicated by reference numerals 1005, 1006, 1007, 1008, as the counter value is incremented from 0 to 1 to 2 to 3. What is obtained by multiplying the value indicated by reference numeral 1002 by the output value 1001 of the look-up table 114 is the output of the monotone decreasing function multiplication circuit 901 and this output becomes straight line 1003. At the adder 119, the output of the monotone decreasing function multiplication circuit 901 and the input signal 902 are added together. The adder 119 has a function of carrying out the following processing: when the result of this addition is larger than the maximum gray scale 1009, the adder changes it to the maximum gray-scale value; and when the result of the addition is smaller than the minimum gray-scale value, the adder changes it to the minimum gray-scale value. The result of the addition is as indicated by straight line 1004. Since a part of the straight line 1004 is larger than the maximum gray scale 1009, the excess value of the part is changed to the maximum gray scale 1009. As a result, the driving gray-scale value obtained when the count value is 0, 1, 2, or 3 is as indicated by reference numeral 1010, 1011, 1012, or 1013. This gray-scale value is converted into driving voltage at the D-A converter 120 and the liquid crystal panel is thereby driven. As a result, it is possible to respond at the maximum response speed of this liquid crystal at the temperature as illustrated in FIG. 6. In this example, a linear function is used as the monotone decreasing function. In the invention, however, the format of the monotone decreasing function is not limited. Any function, including exponential function, logarithm, hyperbolic function, and the like, most suitable for the performance of the liquid crystal panel can be used as long as it is a monotone decreasing function. In this case, it is desirable that a parameter set value (base, index number, intercept, or the like) suitable for that function should be set in the monotone decreasing function parameter setting register 903.

### Fourth Embodiment

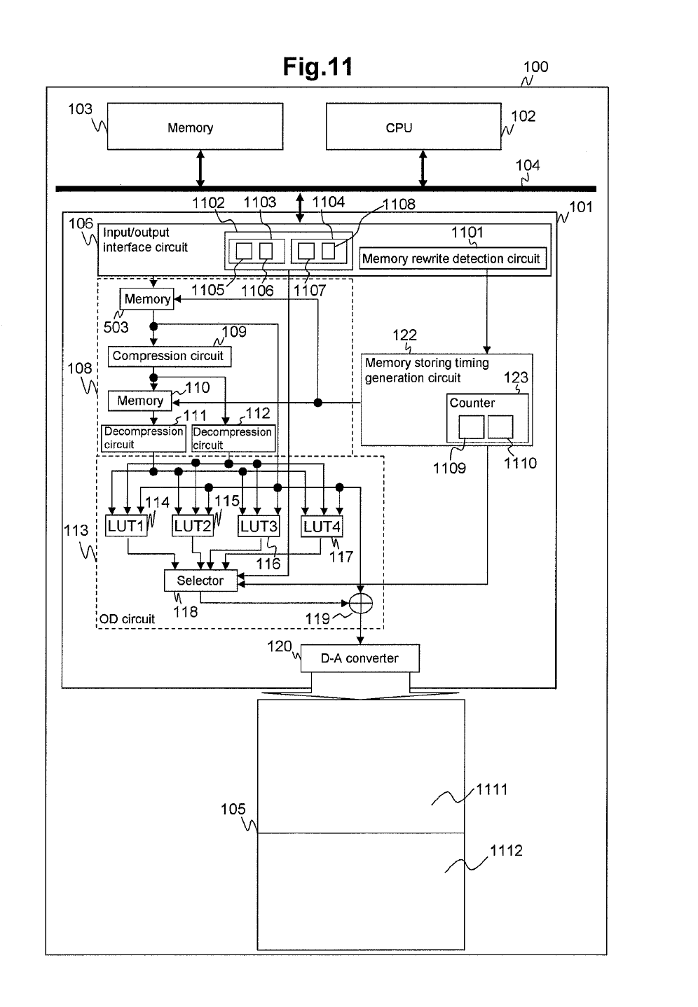

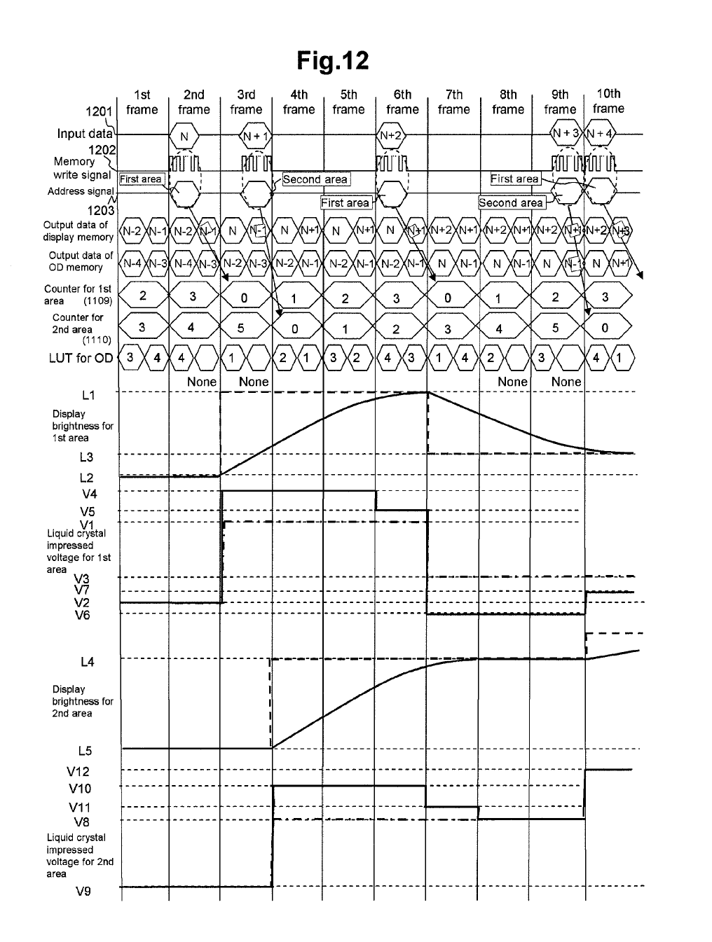

Description will be given to a fourth embodiment with reference to FIG. 11 and FIG. 12. The fourth embodiment is different from the first embodiment in that: a frame memory 503 for storing the present display image is provided; and the CPU 102 writes a display image only when a display image is changed. In the display driving device 101 in the fourth embodiment, the display area in the display panel 105 is divided into multiple areas 1111 and 1112. The display driving device includes: a memory rewrite detection circuit 1101 that detects whether or not rewriting of the display image storage memory by the CPU 102 has occurred in each area; and an area setting register 1102 for setting an area. In the fourth embodiment, the area is divided into, for example, two. It is provided with a register 1103 for setting the coordinates of the upper left vertex of the first area 1111 and a register 1104 for setting the coordinates of the lower right vertex of the first area. The area other than the first area is taken as the second area. x-coordinates are specified in registers 1105, 1107 and y-coordinates are specified in registers 1106, 1108. In the fourth embodiment, the area is divided into two; however, the area may be divided into more areas, needless to add. In the fourth embodiment, the memory storing timing counter 123 is separately provided therein with a counter 1109 for the first area and a counter 1110 for the second area.

Description will be given to the operation of the fourth embodiment with reference to FIG. 12. The CPU 102 writes display data to the memory 503 by way of the internal bus 104 and the input/output interface circuit 106. At this time, it will be assumed that the first display area 1111 and the second display area 1112 are respectively used for different contents and their respective timing of display image change is independent of each other. Possible examples of this includes: cases where one-segment TV moving image is displayed in the first display area 1111 and the content of one-segment text broadcasting is displayed in the second display area 1112; cases where a moving image delivered on the web is displayed in the first display area 1111 and a web screen outside the moving image area is displayed in the second display area 1112; and cases where incoming signal strength, the state of mail reception, or the like is indicated in the first display area 1111 and the content of one-segment television broadcasting, a game application, or the like is displayed in the second display area 1112.

As an example, it will be assumed that in the first display area 1111, display data is rewritten at intervals of four frames in the second, sixth, and 10th frames as illustrated in FIG. 12. Further, it will be assumed that in the second display area 1112, display data is rewritten at intervals of six frames in the third and ninth frames. The memory rewrite detection circuit 1101 checks the following: the set values in the area setting register 1102; an address signal 1202 present in the internal bus 104, issued by the CPU 102 for writing to the memory 503; and a memory write signal 1203. When the memory write signal is detected with the address value of the address signal in the first display area 1111 set in the area setting register 1102, it determines that the first display area 1111 has been rewritten. Then it resets the counter 1109 for the first area in the memory storing timing counter 123 and sets it to “0” when the next frame is started. Similarly, the memory rewrite detection circuit 1101 carries out the following processing when it detects the memory write signal with the address value of the address signal out of the first display area set in the area setting register 1102: it detects that the second display area 1112 has been rewritten and resets the counter 1110 for the second area in the memory storing timing counter 123 and sets it to “0” when the next frame is started.

When the gray-scale value for which overdrive computation is presently carried out is within the first display area, the selector 118 outputs the following on a case-by-case basis according to the counter 1109 for the first area: it outputs the look-up table (LUT1) 1145 when the counter value is 0; it outputs the look-up table (LUT2) 115 when the counter value is 1; it outputs the look-up table (LUT3) when the counter value is 2; it outputs the look-up table (LUT4) when the counter value is 3; and it outputs ‘0’ when the counter value is 4 or above. Similarly, when the gray-scale value for which overdrive computation is presently carried out is within the second display area 1112, the selector 118 outputs the following on a case-by-case basis according to the counter 1110 for the second area; it outputs the look-up table (LUT1) 114 when the counter value is 0; it outputs the look-up table (LUT2) 115 when the counter value is 1; it outputs the look-up table (LUT3) when the counter value is 2; it outputs the look-up table (LUT4) when the counter value is 3; and it outputs “0” when the counter value is 4 or above.

As the result of this operation, the following can be implemented even in the display driving device 101 equipped with the frame memory 503 or even when in a display area, there are multiple areas rewritten with different timing: overdrive driving can be performed so that response can be made at the maximum response speed at the temperature over multiple frames as illustrated in FIG. 12.

Up to this point, concrete description has been given to the invention made by the present inventors based on embodiments. However, the invention is not limited to these embodiments and can be variously modified without departing from the subject matter thereof, need less to add.

Some examples will be taken. The invention can be implemented by combining the second embodiment and the fourth embodiment, needless to add. Also in the fourth embodiment, the overdrive circuit can be implemented by a method in which the monotone decreasing function described in relation to the third embodiment is multiplied. The display driving device denoted by reference numeral 101 may be formed of a single semiconductor chip. The display driving system 100 may be formed in a single semiconductor substrate as a microcomputer, an accelerator, or SOC or may be formed as a multi-chip module. The invention is widely applicable to display driving devices and display driving systems for liquid crystal displays for, for example, cellular phones and portable game devices and in-vehicle displays.

What is claimed is:

1. A display driving device forming gray scale driving voltage based on a display gray-scale value supplied from a central processing unit and driving a display panel,
wherein in response to a change of display gray-scale values supplied from the central processing unit, overdrive control is carried out which performs driving with a plurality of gray scale driving voltages, the difference of that and a gray-scale value before the change is larger than the difference gray scale driving voltage corresponding to gray-scale value after the change and before the change in terms of absolute value before gray scale driving voltage is reached to a driving voltage corresponding to a display gray-scale value after the change.

2. The display driving device according to claim 1, comprising:
a plurality of look-up tables which receives a display gray-scale value before the change and a display gray-scale value after the change and forms an output corresponding to the inputted display gray-scale values;
a selector selecting the outputs of the look-up tables; and
a timing generation circuit controlling section by the selector,
wherein the timing generation circuit changes selection of the look-up tables according to the number of periods that lapse with respect to display frame periods starting at a change of display gray-scale values supplied from the central processing unit, and
wherein overdrive control is carried out which performs driving with the gray scale driving voltages,the difference the driving voltage and the driving voltage before the change is larger than the difference gray scale driving voltage corresponding to gray-scale value after the change and before the change in terms of absolute value based on output selected by the selector.

3. The display driving device according to claim 1, comprising:
a look-up table which receives a display gray-scale value before the change and a display gray-scale value after the change and forms an output corresponding to the inputted display gray-scale values;
a computation circuit which receives a plurality of outputs of the look-up table and carries out computation; and
a timing generation circuit which controls computation by the computation circuit,
wherein the computation circuit multiplies the result of computation of a monotone decreasing function with the number of periods that lapse with respect to display frame periods starting at a change of display gray-scale values supplied from the central processing unit taken as a variable by an output of the look-up table,
wherein the timing generation circuit supplies the variable to the computation circuit, and
wherein overdrive control is carried out which performs driving with the gray scale driving voltages,the difference the driving voltage and the driving voltage before the change is larger than the difference gray scale driving voltage corresponding to gray-scale value after the change and before the change in terms of absolute value based on the output of computation carried out at the computation circuit.

4. The display driving device according to claim 2, comprising:
a buffer memory temporarily storing data of display gray-scale values at each interval between changes of display gray-scale values supplied from the central processing unit,
wherein the look-up table forms an output based on a display gray-scale value supplied from the central processing unit in synchronization with display timing and a display gray-scale value read from the buffer memory in synchronization with display timing.

5. The display driving device according to claim 4,
wherein the interval between changes of display gray-scale values is a period whose minimum unit is one display frame period, and
wherein the timing control circuit comprises a counter counting the duration of each interval between changes of the display gray-scale values and carries out control to rewrite the display gray-scale value of an identical pixel on the buffer memory in each period of counting operation of the counter.

6. The display driving device according to claim 5, comprising:
a register in which a muximum value of the counter is initially set by the CPU.

7. The display driving device according to claim 4, comprising:
a compression circuit compressing a display gray-scale value supplied from the central processing unit; and
a second decompression circuit decompressing the output of the buffer memory,
wherein the buffer memory stores a display gray-scale value compressed at the compression circuit, and
wherein the look-up table receives a display gray-scale value obtained by decompressing, at the second decompression circuit, a compressed display gray-scale value read from the buffer memory, and a display gray-scale value supplied from the central processing unit.

8. The display driving device according to claim 7, comprising:
a first decompression circuit decompressing the output of the compression circuit,
wherein the look-up table carries out the overdrive control on condition that a display gray-scale value supplied by way of the compression circuit and the first decompression circuit and a display gray-scale value obtained by decompressing a compressed display gray-scale value read from the buffer memory at the second decompression circuit disagree with each other.

9. The display driving device according to claim 2,
wherein the timing control circuit comprises a counter repeating the operation of counting the number of the display frame periods that lapse from an initial value to a specified value and changes selection by the selector based on the count value of the counter.

10. The display driving device according to claim 3,
wherein the timing control circuit comprises a counter repeating the operation of counting the number of the display frame periods that lapse from an initial value to a specified value and supplies the count value of the counter to the computation circuit as a variable.

11. A display driving device forming gray scale driving voltage based on a display gray-scale value supplied from a central processing unit and driving a display panel,
wherein in response to a change of display gray-scale values supplied from the central processing unit, overdrive control is carried out which performs driving with a plurality of gray scale driving voltages, the difference the driving voltage and the driving voltage before the change is larger than the difference gray scale driving voltage corresponding to gray-scale value after the change and before the change in terms of absolute value before gray scale driving voltage is reached arising from a display gray-scale value after the change with respect to each display area in the display panel.

12. A display driving system comprising:
the display driving device according to claims 1;
a central processing unit supplying a display gray-scale value to the display driving device to carry out control; and
a display panel driven by driving voltage formed by the display driving device,
wherein the display panel is comprised of pixel electrodes with specific TFTs coupled thereto arranged in a matrix pattern opposite to a common electrode, a plurality of scanning lines comprising the selection paths of the TFTs, and a plurality of signal lines comprising the current paths of the TFTs, and
wherein the display driving device drives the signal lines in synchronization with driving of the scanning lines.

13. A display driving system comprising:
the display driving device according to claims 11;
a central processing unit supplying a display gray-scale value to the display driving device to carry out control; and
a display panel driven by driving voltage formed by the display driving device,
wherein the display panel is comprised of pixel electrodes with specific TFTs coupled thereto arranged in a matrix pattern opposite to a common electrode, a plurality of scanning lines comprising the selection paths of the TFTs, and a plurality of signal lines comprising the current paths of the TFTs, and
wherein the display driving device drives the signal lines in synchronization with driving of the scanning lines.
